(19) United States
(12) Patent Application Publication
(10) Pub. No.: US 2007/0164534 A1
(43) Pub. Date: Jul. 19, 2007

(54) BICYCLE FRONT WHEEL DRIVE ASSEMBLY

(76) Inventor: Robert L. Simon, Mt. Clemens, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/612,299

(22) Filed: Dec. 18, 2006

Related U.S. Application Data
(60) Provisional application No. 60/752,821, filed on Dec. 22, 2005.

(51) Int. Cl. B62M 1/14

(52) U.S. Cl. 280/242.1

(57) ABSTRACT

A drive assembly associated with a front wheel of a wheeled conveyance having a crosswise extending and linear shaped handle. A pair of sliding handle gripping portions are attached to extending ends of the handle, the gripping portions being linearly translated in first and second directions to continuously drive a closed loop belt extending within the handle. A drive shaft is operably engaged at a first end to the continuously driven closed loop belt. An extending end of the drive shaft operably engages the front wheel of the conveyance, such that actuation of the gripping portions is translated to forward rotating motion of the wheel.

### CROSS-REFERENCE TO RELATED APPLICATIONS

This application is a Non-Provisional Utility Filing based upon Provisional (35 USC 119(e)) application U.S. Ser. No. 60/752,821 filed on Dec. 22, 2005 and entitled “Front Wheel Drive Device for a Wheeled Conveyance ”.

### FIELD OF THE INVENTION

The present invention is a front wheel drive actuated device, utilizing the hands and arms of a user, and in order to propel a wheeled conveyance, such as a bicycle, tricycle or other type of wheeled conveyance. In particular, the wheel drive actuated device includes, in a preferred variant, a pair of linearly translatable gripping handles associated with a crosswise extending front handle bar. Continuous translating motion (e.g. inward and outward motion) imparted to the gripping handles in turn operates a bevel gear and drive shaft arrangement communicating with a front wheel of the conveyance, such as by means of a continuous belt drive extending within the handle, and in order to drive the wheel.

### BACKGROUND OF THE INVENTION

The prior art is well documented with varying types of drive mechanisms for use with a bicycle, these either augmenting or operating alternatively from a primary pedal and chain design for driving the rear wheel. A number of the relevant prior art references in particular disclose additional drive assemblies dedicated to actuating the front wheel of the bicycle.

A first example is disclosed in U.S. Pat. No. 4,900,045, issued to Myers, and which teaches an alternative drive device for a bicycle including a drive wheel assembly which is rotatably and (selectively) frictionally engaged with a bicycle front wheel. The drive wheel assembly has two drive shafts and a drive wheel with dual ratchet assemblies therein. A vertical frame is provided for mounting the drive wheel assembly in frictional engagement with the bicycle front tire and is connected to a first horizontal bar. The vertical frame extension includes first and second horizontal extending bars, a pair of handles slidably mounted on the second horizontal bar and in turn attached to a cable and pulley system that engages the drive wheel assembly and is capable of driving the device by reciprocal motion along the second horizontal bar wherein the motion of the handles causes the drive wheel, and hence the bicycle's front tire, to rotate.

European Patent Specification No. 0 541 136 teaches a mechanism for driving a bicycle front wheel including a chain connected to the front wheel. A handle bar is detached from a steering column by means of a retractable catch and, in the detached position, the handlebar transmits, via the chain, the swinging movement to drive the front wheel. Of note, the handlebar is fixed to an upside-down “U” shaped lever hinged to the upper part of a front disposed bicycle fork. The transmission means in the form of the chain is drivingly connected to at lest one arm of the “U” shaped lever and passes around an idler wheel.

U.S. Pat. No. 5,542,689, issued to Chalfant, teaches a front wheel drive system for a bicycle which can be installed on a bicycle to drive the front wheel by means of rocking handlebars back and forth. A chain is positioned and a support mechanism to the handlebar of the bicycle. The handlebar is attached to a rotatable outer sleeve of a handle bar stem. A rocker switch in the outer sleeve selectively locks the handle bar relative to the stem or allows the handle bar to rotate about the stem. A chain attached to the chain positioning and support mechanism engages a freewheel attached to the front hub of a bicycle and terminates in a spring connecting back to the chain positioning and support mechanism.

U.S. Pat. No. 6,688,623, issued to Yunaska, teaches an alternative variant of front rocking motion (about a horizontal and lineal axis) of a front handlebar drive assembly. U.S. Pat. No. 7,021,639, to Park, teaches another type of push-pull arrangement for driving a bicycle front wheel in cooperation with a standard rear wheel pedal and chain drive. Several additional front wheel rotary type chain drives are collectively referenced in Pat. Nos. 4,147,370 (Lindsey, Jr.), 6,264,224 (Phillips), 6,099,009 (Schroeder), 5,908,199 (Rigato) and 4,858,942 (Rodriguez).

### SUMMARY OF THE INVENTION

The present invention discloses a drive assembly (auxiliary or alternate to a conventional rear pedal and chain drive) associated with a front wheel of a wheeled conveyance and including a crosswise extending and linear shaped handle. A pair of sliding handle gripping portions in one variant extend horizontally and are attached to extending ends of the handle, the gripping portions being linearly translated in first and second directions to continuously drive a closed loop belt extending within the handle.

A drive shaft is operably engaged at a first end to the continuously driven closed loop belt. An extending end of the drive shaft operably engages the front wheel of the conveyance, such that actuation of the gripping portions is translated to forward rotating motion of the wheel.

Another variant contemplates vertically or otherwise angularly offset extending (and as opposed to horizontally extending) handles for purposes of more comfortably driving the assembly. This would further contemplate mounting the handles to inboard ends of the horizontal tubing, via such as clamp mounts which can be moved fore and aft by selective loosening and retightening of the mounts. It is further contemplated that the angular orientation of each of the vertically extending handlebars could further be adjusted to provide maximum comfort and efficiency.

Additional features include interior gears associated with the handle portions in turn acting upon gripper portions communicating with locations associated with the belt. The handles each further including pairs of spaced apart and elongate crosswise extending slots communicating the sliding gripping portions with the belt.

Also, the drive shaft may extend in journalled fashion within a hollow outer tube associated with the frame structure of the wheeled conveyance, e.g. bicycle. The tube includes at least one of a linear and an articulated (angled) dependent upon a design of the wheeled conveyance.

Tensioning rollers are located in communication with at least one overlapping side of the belt and a drive wheel is located within a central three-dimensional cavity extending between the extending portions of the handlebar and operatively communicating with the drive shaft. Interior bearings maintain a freely rotatable and journalled arrangement of the drive shaft within the hollowed outer tube.

The hollowed outer tube further includes a lower projecting and telescoping portion, this shock absorbingly biased relative to an upper, outer and fixed tube, and by virtue of at least one of an interior spring or a fluid cylinder arrangement to provide adequate forward shock absorption to the assembly.

A lower end of the drive shaft terminates in a first bevel gear. A second bevel gear is mounted in rotatably engaging and offset fashion relative to the first gear and is arranged in proximity about a center rotating axis of the front wheel. The front wheel further includes a ring array exhibiting an outer knurled or teeth surface such that, upon interengaging rotation of the first and second bevel gears, a rotating output of the second gear is directed to the ring, causing the same to rotate along with the wheel.

### BRIEF DESCRIPTION OF THE DRAWINGS

Reference will now be made to the attached drawing, when read in combination with the following detailed description, wherein like reference numerals refer to like parts, and in which:

FIG. 1 is an illustration of a front wheel drive actuated conveyance according to a preferred embodiment of the present invention;

FIG. 2 is an overall illustration of a bicycle device incorporating the front wheel drive actuated conveyance;

FIG. 3 is an exploded view illustrating the structure associated with the wheel drive actuated conveyance;

FIG. 4 is an illustration of an alternate configuration of a drive shaft arrangement and referencing the resizable nature of the associated drive gears and pulleys;

FIG. 5 is an illustration of an alternate variant whereby vertically extending and repositionable gripping handles are substituted for the horizontally disposed handles, the vertical handles further capable of being adjusted angularly relative to a vertical axis to provide maximum flexibility and comfort to a user; and

FIG. 6 is an illustration of a modified variant incorporating a framework supporting handles combined with brake portions and optional shifter controls.

### DETAILED DESCRIPTION OF THE PREFERRED EMBODIMENTS

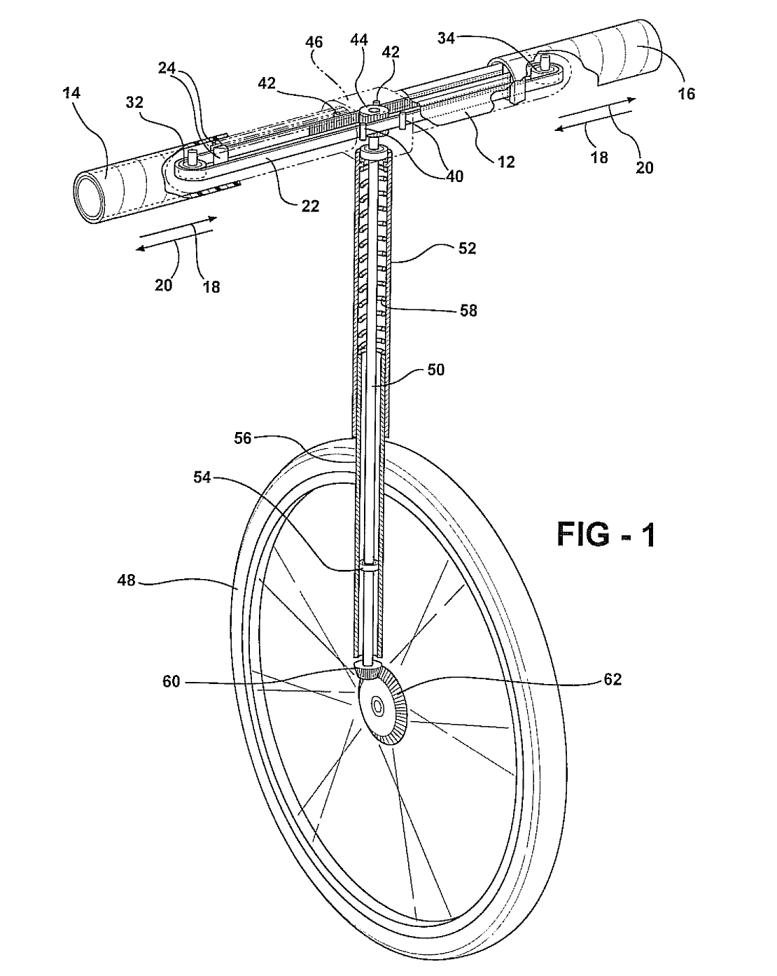

Referring now to FIG. 1, a general illustration is shown at 10 of a front wheel drive actuating drive assembly for use with a wheeled conveyance according to a preferred embodiment of the present invention. As previously described, the present invention discloses a forward wheel manually actuating drive assembly, such as which can be used alternatively or in combination with a conventional rear wheel pedal drive, and in order to propel the wheeled conveyance forwardly.

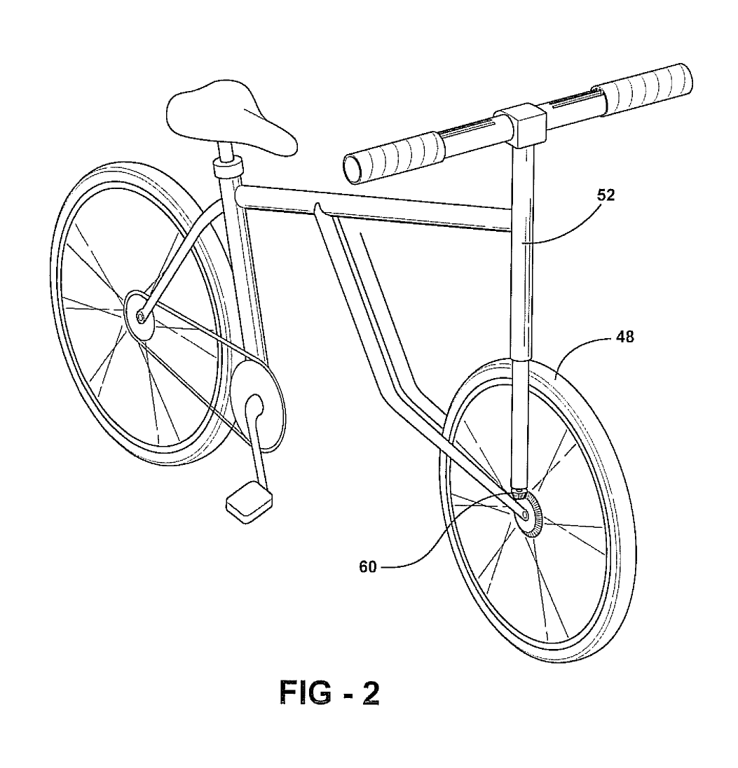

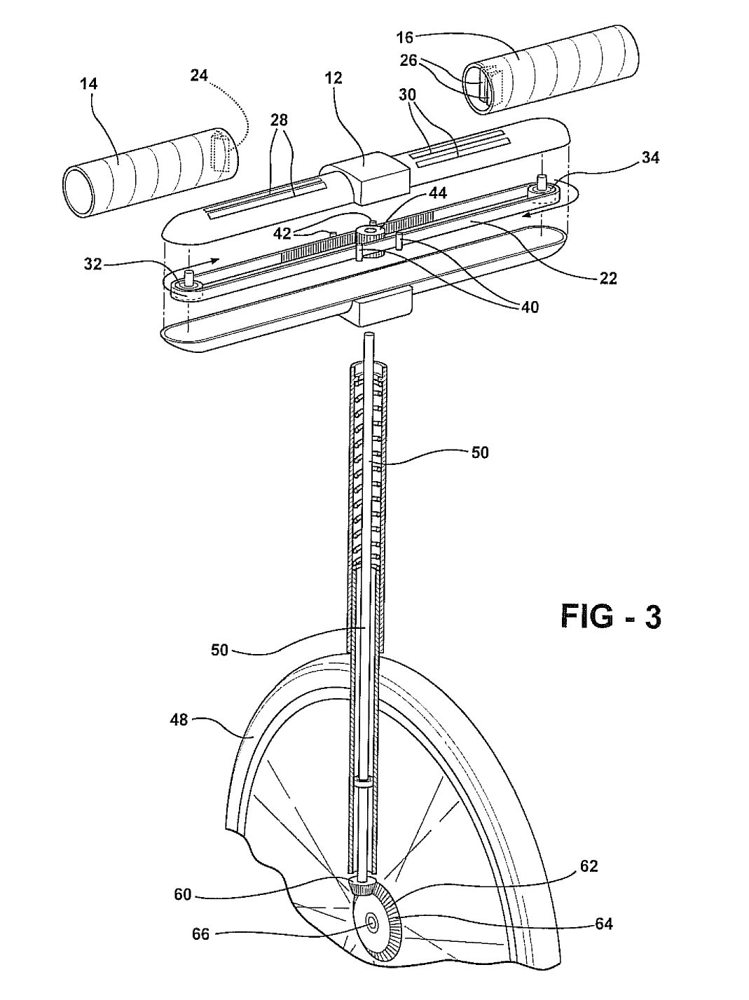

As illustrated in FIG. 1, as well as the succeeding views of FIGS. 2 and 3, the conveyance 10 includes a crosswise extending and substantially linear handle 12. Attached to the opposite ends of the handles are a pair of sliding handle gripping portions 14 and 16. The gripping portions 14 and 16 are linearly translated in opposite directions, see directional arrows 18 and 20 in FIG. 1, and by which the gripping portions are caused to continuously drive a continuous and closed loop belt 22 extending within the handle 12. It is further understood that the gripping portions 14 and 16 may be configured to control driving action of the belt 22 according to any of in, out, bilinearly or locked fashion within the scope of the present invention.

Referring also to FIG. 3, the mechanism for actuating the belt drive includes the provision of belt grippers 24 and 26 located upon the sliding handle portions 14 and 16. The grippers 24 and 26 can engage the exteriorly mounted handle portions such as through slots 28 and 30 formed through the handle portions. Although two slots are identified, it is further understood that any suitable configuration for imparting driving force from the gripping portions to the belt can be substituted, not limited to a single such slot, multiple slots, or any other desired arrangement. In a preferred variant, an interior gear, see at 32 and 34, is mounted within each of the handle portions 14 and 16, the purpose for which being to rotatably coact with the pairs of belt grippers 24 and 26, and in order to drive the belt in a continuous looped direction, see as shown by arrows 36 and 38 in FIG. 3.

Additional structure associated with the crosswise extending linear handle 12 includes the provision of tensioning rollers (see at 40 and 42 in FIGS. 1 and 3) located on either or both of the overlapping sides of the belts and in order to both tension the belts as well as to tension a drive wheel 44 located within a central three-dimensional cavity 46 between the extending portions of the handlebar. As is known, the belt 22 comprises a replaceable item and includes an interiorly toothed surface which, as a result of it being continuously driven, operates to rotate the drive wheel 44 in a likewise fashion.

In order to translate the rotating motion of the drive wheel 44 to a front wheel 48 associated with the conveyance, a drive shaft 50 extends from the drive wheel 44, and such as substantially downward in journalled fashion within a hollow outer tube 52 associated with the frame structure of the bicycle. As additionally illustrated in the bicycle variant of FIG. 2, the tube 52 can be linear or articulated (angled) dependent upon the design of the wheeled conveyance.

Referring again to FIG. 1, the drive shaft 50 is typically supported such as by interior bearings 54 or the like, and in order to maintain its ideal and freely rotatable arrangement within the tube 52. As is also illustrated in FIG. 1, the tube 52 may also include a lower projecting 56 and telescoping portion, and which is shock absorbingly biased by virtue of an interior spring 58 or, alternatively, a fluid cylinder arrangement (not shown) in order to provide adequate forward shock absorption to the assembly. It is also envisioned that the drive shaft, in this variant, would include a suitable slip ring or like arrangement to accommodate for any degree of compression or extension of the telescoping tubular portions, ranging from minute to extensive applications.

A lower end of the drive shaft 50 terminates in a first bevel gear 60, such as which is typically defined integrally with the end of the shaft 50. A second bevel gear 62 is mounted in rotatably engaging and offset fashion relative to the first gear 60, such as within a housing (not shown) arranged in proximity about the center rotating axis of the front wheel 48.

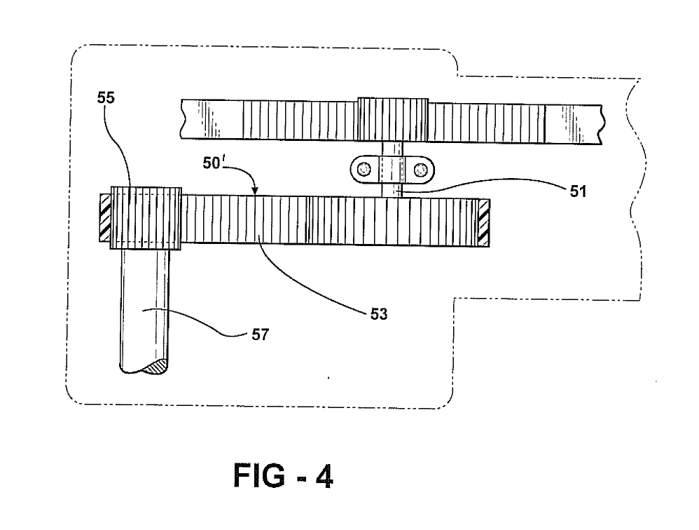

The drive shaft may also be repositioned in an outboard fashion, as compared to what is illustrated in FIG. 1, this in order to reposition outside the bicycle wheel. This further enables a user to effectively change the drive ratio of the gears through the provision of a differently sized pulley and/or belt. Reference is made to assembly 50 ′ in FIG. 4 and which generally illustrates a selective drive ratio arrangement by which a first (input) gear assembly 51 operatively engages a pulley 53 at one end, and output drive component of the pulley 53 being communicated to a second (output) gear 55 and attached shaft drive 57 for subsequent communication to the front drive wheel.

As is most clearly illustrated in FIG. 3, one variant of the present design contemplates the front wheel 48 including a circular ring array 64, concentrically located about its center point of rotation 66. The ring array 64 exhibits an outer knurled or teeth surface such that, upon interengaging rotation of the first and second bevel gears 60 and 62, a rotating output of the second gear 62 is rotated directly to the ring 64, causing the same to rotate along with the wheel 48. It is also understood that a suitable and freewheeling clutch assembly is built into the front wheel drive, and such as which permits forward coasting of the bicycle.

It is also envisioned that, according to further embodiments, the first gear 60 may be repositioned in order to directly actuate the ring array 64 in rotating fashion. It is further envisioned that other alternate variants contemplate other types of linkage effectively translate a rotating output of the shaft 50 into forward rotating and driving motion of the wheel 48. In particular, utilization of an internally geared multi-speed hub (e.g. wheel hub) could be employed, among other structures, in order to provide forward propelling motion to the front wheel.

In a preferred embodiment, timing of the inner/outer translating motion of the gripping handles 14 and 16 is coordinated with the breathing of the individual and in order to provide a highest degree of effective driving motion. Additional advantages of the present design include the cardiovascular benefits provided by the exercise associated with actuating the handles. This is additional to the limitation of stresses on the user's upper body, as well as eccentric force motions associated with non-linear and force equalizing actuating of opposite gripping handles such as in the present design, this often having an undesirable affect on the balancing forces of the wheeled conveyance.

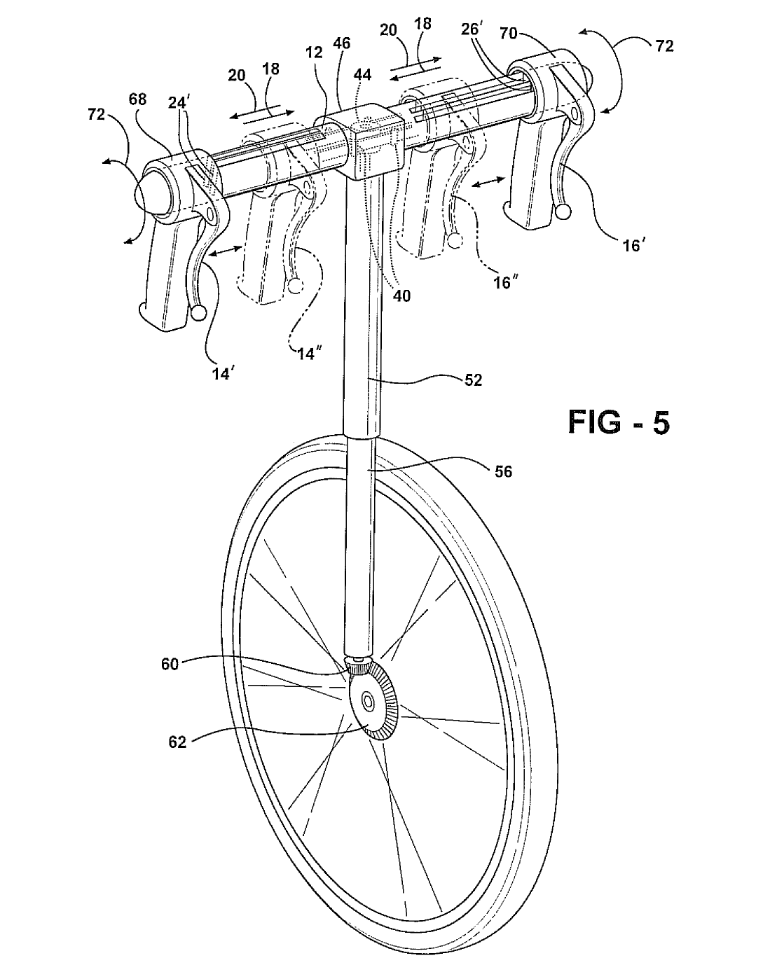

Referring to FIG. 5, an illustration is shown of an alternate variant of a handle bar driven assembly, utilizing substantially the components illustrated in FIG. 1, and with vertically extending and repositionable gripping handles, see 14′ and 16′, being substituted for the horizontally disposed handles previously shown at 14 and 16 in the initial embodiment of FIG. 1. The provision of the vertical gripping portions is intended to maximize the manual effort input resulting from the ability to employ two sets of wrist and arm muscles, this accomplished by the 90° rotation of the user's wrists.

The construction of the drive assembly is as substantially previously described and illustrated in FIG. 1, these elements being substantially represented and a repetitive description wherefore being unnecessary. The gripping portions 14′ and 16″ according to this variant are mounted to selective linear extending locations of the handle 12, such as by clamp type mounts (see further at 68 and 70 for gripping portions 14′ and 16′ and which may include loosenable and retightenable screw portions), these further capable of being adjusted angularly or rotatably (see at 72) about a linear axis extending through the handle and relative to a vertical direction in order to provide maximum flexibility and comfort to a user. It is further contemplated that the gripping portions 14′ and 16′ may be initially mounted to an inboard end locations of the tubing (see at 14″ and 16″ in phantom in FIG. 5 and which would permit initial opposite outward and repetitively opposing inward drive motions), however it is also contemplated that the gripping portions can be initially mounted to outboard ends of the handle 12, with the drive and return motions being reversed. It is also envisioned the assembly can be reconfigured to drive both inboard (inward) as well as outboard (or outward) within the scope of the invention.

Other and additional preferred embodiments will become apparent to those skilled in the art. In particular, the types of wheeled conveyances capable of being utilized with the present invention, while primarily including bicycles, can encompass such as three-wheeled tricycle designs, as well as being utilized either alone or in combination with a manual, electric, or gasoline operated rear wheel propulsion system.

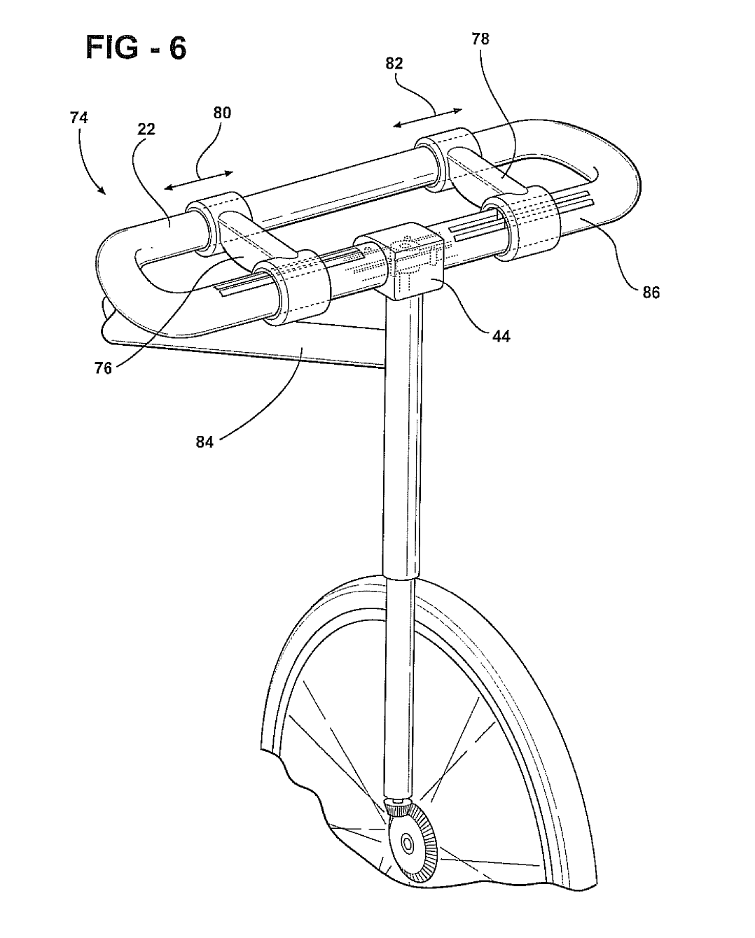

It is also envisioned that a dust/environmental cover (not shown) can be employed to protect the assembly. Also, the system (e.g. in particular the gripping portions) can be modified to incorporate the brake and shifter components (see FIG. 6) of the bicycle within the scope of one of ordinary skill in the art.

Referring finally to FIG. 6, at 74 is generally shown an illustration of a modified handlebar assembly in which modified gripping portions are combined with conventional braking portions and as shown at 76 and 78 for traversing motion in co-linear fashion, see at 80 and 82. Of note, braking portions 84 and 86 can be accessed by such as a user's outer (fore and index) fingers. Additionally, shifter portions (not shown) can also be incorporated into any ergonomically accessible location, in cooperation with the gripping, drive and braking components so as to facilitate ease of operation.

I claim:

1. A drive assembly associated with a front wheel of a wheeled conveyance, comprising:
a crosswise extending and linear shaped handle;
a pair of sliding handle gripping portions attached to locations of said handle, said gripping portions being linearly translated in first and second directions to continuously drive a closed loop belt extending within said handle; and
a drive shaft operably engaged at a first end to said continuously driven closed loop belt, an extending end of said drive shaft operably engaging the front wheel of the conveyance such that actuation of said gripping portions is translated to forward rotating motion of the wheel.

2. The assembly as described in claim 1, further comprising interior gears associated with said handle portions in turn acting upon gripper portions communicating with locations associated with said belt.

3. The assembly as described in claim 2, said handle further comprising pairs of spaced apart and elongate crosswise extending slots communicating said sliding gripping portions with said belt.

4. The assembly as described in claim 1, further comprising said drive shaft extending in journalled fashion within a hollow outer tube associated with said frame structure of the wheeled conveyance.

5. The assembly as described in claim 4, further comprising said tube including at least one of a linear and an articulated (angled) dependent upon a design of the wheeled conveyance.

6. The assembly as described in claim 1, further comprising tensioning rollers located in communication with at least one overlapping side of said belt.

7. The assembly as described in claim 6, further comprising a drive wheel located within a central three-dimensional cavity extending between the extending portions of said handlebar and operatively communicating with said drive shaft.

8. The assembly as described in claim 4, further comprising interior bearings maintaining freely rotatable and journalled arrangement of said drive shaft within said hollowed outer tube.

9. The assembly as described in claim 4, said hollowed outer tube further comprising a lower projecting and telescoping portion, shock absorbingly biased relative to an upper, outer and fixed tube by virtue of at least one of an interior spring and a fluid cylinder arrangement to provide adequate forward shock absorption to the assembly.

10. The assembly as described in claim 1, further comprising a lower end of said drive shaft terminating in a first bevel gear, a second bevel gear being mounted in rotatably engaging and offset fashion relative to said first gear and arranged in proximity about a center rotating axis of the front wheel.

11. The assembly as described in claim 10, the front wheel further comprising a ring array exhibiting an outer knurled or teeth surface such that, upon interengaging rotation of said first and second bevel gears, a rotating output of said second gear is directed to said ring, causing the same to rotate along with the wheel.

12. The assembly as described in claim 1, said gripping portions each having a specified shape and size and being repositionably adjusted to selected locations associated with said handle such that said gripping portions each extend at an angle relative to said handle.

13. The assembly as described in claim 12, further comprising first and second clamp mounts for securing said gripping portions to said handle, said clamp mounts permitting said gripping portions to be readjusted about a lineal axis extending through said handle.

14. The assembly as described in claim 13, each of said gripping portions exhibiting a selected shape and size and securing to respective inboard end mounting locations of said handle.

15. A drive assembly associated with a front wheel of a wheeled conveyance, comprising:
a crosswise extending and linear shaped handle;
a pair of sliding handle gripping portions attached in angularly extending fashion relative to selected locations of said handle, said gripping portions adapted to being grasped by the hands of a user and being linearly translated in first and second directions to continuously drive a closed loop belt extending within said handle; and
a drive shaft operably engaged at a first end to said continuously driven closed loop belt, an extending end of said drive shaft operably engaging the front wheel of the conveyance such that actuation of said gripping portions is translated to forward rotating motion of the wheel.

16. The assembly as described in claim 15, further comprising first and second clamp mounts for securing said gripping portions to said handle, said clamp mounts permitting said gripping portions to be readjusted about a lineal axis extending through said handle.

17. The assembly as described in claim 15, further comprising interior gears associated with said handle portions in turn acting upon gripper portions communicating with locations associated with said belt.

18. The assembly as described in claim 17, said handle further comprising pairs of spaced apart and elongate crosswise extending slots communicating said sliding gripping portions with said belt.

19. The assembly as described in claim 15, further comprising said drive shaft extending in journalled fashion within a hollow outer tube associated with said frame structure of the wheeled conveyance.

20. The assembly as described in claim 15, further comprising a lower end of said drive shaft terminating in a first bevel gear, a second bevel gear being mounted in rotatably engaging and offset fashion relative to said first gear and arranged in proximity about a center rotating axis of the front wheel, the front wheel further comprising a ring array exhibiting an outer knurled or teeth surface such that, upon interengaging rotation of said first and second bevel gears, a rotating output of said second gear is directed to said ring, causing the same to rotate along with the wheel.
